(19) United States
(12) Patent Application Publication
(10) Pub. No.: US 2004/0055541 A1
(43) Pub. Date: Mar. 25, 2004

(54) Doggie poop freeze wand

(76) Inventor: Mary S. Brock, Los Angeles, CA (US)

Correspondence Address: Mary S. Brock, 9137 Halldale Ave., Los Angeles, CA, 90047, US

(21) Appl. No.: 10/425,108

(22) Filed: Apr. 29, 2003

Related U.S. Application Data
(60) Provisional application No. 60/382,823, filed on May 24, 2002.

(51) Int. Cl. A01K 29/00

(52) U.S. Cl. 119/161

(57) ABSTRACT

Some of the most recent products in the field that my invention pertains to are: Canned air products, to clean computer and other small electronic equipment; Doggie Dooley Waste Terminator, Lim'nate Stool Super Concentrated Digester, and The Grabber Dooley Doo Scoop are all existing pet care products used for the purpose of making disposal of animal waste easier. My invention exceeds the efforts of these products by combining practically all of their conveniences and benefits, with minimal effort.

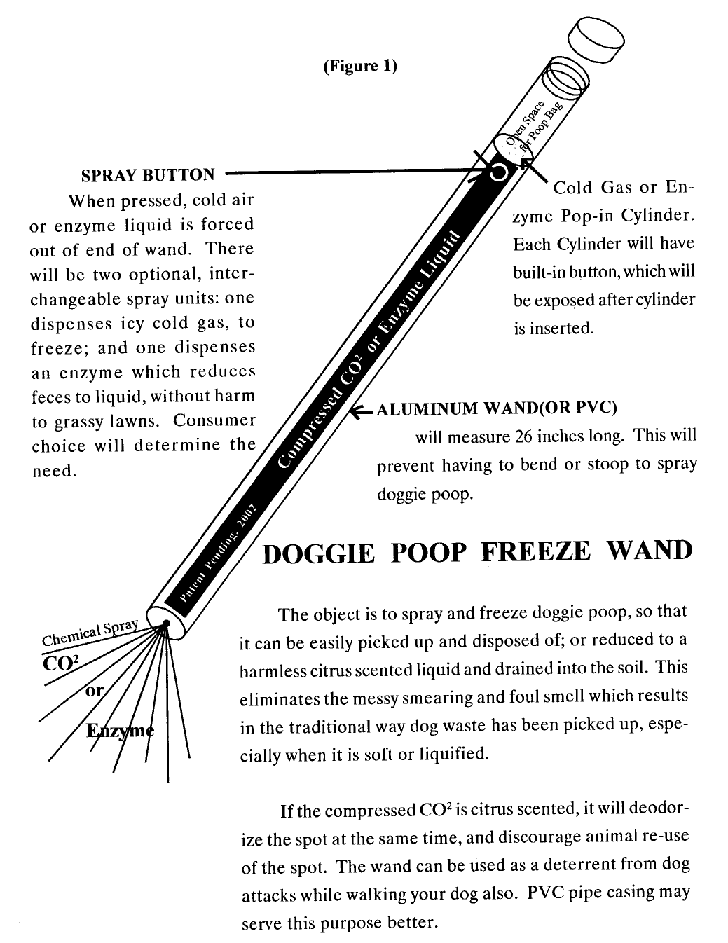

### CROSS-REFERENCE TO RELATED APPLICATIONS

“Not Applicable”.

### STATEMENT REGARDING FEDERALLY SPONSORED RESEARCH OR DEVELOPMENT

“Not Applicable”.

### REFERENCE TO SEQUENCE LISTING, A TABLE, OR A COMPUTER PROGRAM LISTING COMPACT DISC APPENDIX

“Not Applicable”.

### BACKGROUND OF THE INVENTION

I believe that the field of endeavor to which this invention pertains is “Chemicals and Allied Products”. The intended use will require the use and distribution of a chemical process, in compressed form, in either case mentioned. The particular chemical formula and process used must be environmentally safe, due to the fact that it will be used in places where humans and animals frequent and come in contact with.

The specific problems which are in existence in the absence of this invention are:

1. The clean-up of animal feces is tedious, smelly, and messy.

2. The disposal of animal feces causes bulk, odors in trash or disposal areas, and unsanitary conditions.

3. The content of feces causes distruction and degradation of properties.

4. The natural body function of our animals is sometimes a nuisance to society.

### BRIEF SUMMARY OF THE INVENTION

My invention will provide an easier, less tedious way to eliminate animal feces. It would definitely be less smelly and messy, in the case of loose stools. If the liquid solution is the choice, the bulk of the stools would be dissolved into the ground; therefore, eliminating bulk and odors in trash and disposal areas. My suggested citrus scented solution would make areas used for elimination more pleasant smelling.

### DETAILED DESCRIPTION OF THE INVENTION

The casing of the invention will be made of aluminum or PVC tubing. It will measure 26 inches in length. This length will allow the holder to comfortably point the device close enough to the ground to have sufficient chemical to reach and concentrate the feces. It will also prevent the holder from having to bend or stoop to spray doggie poop. There will be two optional pop-in cylinders to choose from. Each Cylinder will have built-in button, which will be exposed after cylinder is inserted.

When the button is pressed, the cold air or enzyme liquid is forced out of the end of the wand. The two optional interchangeable spray units will dispense icy cold gas, to freeze the feces, or enzyme, to reduce the feces to liquid without harm to the grassy lawns. The solution canister will be loaded into the cylinder so that the affixed button will line up with the hole in the cylinder and pop through as it is pushed downward toward the opposite end. When the solution canister reaches its end point there will be enough space left between the canister and the screw-on top to place empty plastic bags, to dispose of waste. The demand will depend upon the consumer's choice and situational need. The refill frequency will depend upon the size of the job to be done and how often the wand is used. The wand can be made larger for larger jobs, with more concentrated chemical solutions.

The object is to spray and freeze doggie poop, so that it can be easily picked up and disposed of before it becomes offensive; or to reduce the feces to a harmless citrus scented liquid and allow it to drain into the soil. This eliminates the messy smearing and foul smell which results in the traditional way dog waste has been picked up, especially when it is soft or liquified.

If the compressed chemical is citrus scented, it will deodorize the spot at the same time, and discourage animals' re-use of the spot. The wand can be used as a deterrent from dog attacks while walking your dog also. PVC pipe casing may serve this purpose better. Another use for the wand would be for disposal of human feces, when proper elimination is not an option, in various unforseen circumstances. It may even be used by the military forces while in battle on baron lands.

What I claim as my invention is:

1. The process and utilization of a device which uses formulated chemicals (compressed gas and/or other chemicals) which create a citrus scented spray that will be used in a compressed form and stored in a cylindrical puncture-proof container, as diagrammed, until the need arrives for use, for the purpose of spraying and freezing animal feces or spraying and reducing animal feces to liquid form, for a more acceptable disposal.
